(19) United States
(12) Patent Application Publication
(10) Pub. No.: US 2024/0241242 A1
(43) Pub. Date: Jul. 18, 2024

(54) TAGLESS INDOOR USER LOCALIZATION USING ULTRA-WIDEBAND COMMUNICATION

(71) Applicant: GOOGLE LLC, Mountain View, CA (US)

(72) Inventor: Dongeek Shin, Mountain View, CA (US)

(21) Appl. No.: 18/016,730

(22) PCT Filed: Aug. 24, 2022
(86) PCT No.: PCT/US22/41356

§ 371 Date: Jan. 18, 2023

(51) Int. Cl. G01S 13/06; G01S 13/87

(52) U.S. Cl. CPC G01S 13/06; G01S 13/878

(57) ABSTRACT

To determine a location of a user, a tagless indoor positioning system is automatically calibrated by transmitting communication signals between at least two anchor devices and a user device to determine and store locations of a user with channel impulse responses of the communication signals for each location. A first anchor device at a first fixed location within a positioning system receives a communication signal transmitted by a second anchor device at a second fixed location within the positioning system, where the user is not using the user device. The first anchor device determines a channel impulse response of the communication signal. A location of the user is determined within the positioning system by comparing the channel impulse response of the communication signal to the stored channel impulse responses and corresponding stored locations.

### FIELD OF THE DISCLOSURE

This disclosure relates to indoor tracking using ultra-wideband (UWB) communications, and more specifically, to using anchor devices to communicate with each other to locate a user who is not using or does not have a proximate user device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Today, ultra-wideband (UWB) communication can be used to locate a user by transmitting UWB signals between a user device and an anchor device to determine the distance between the devices based on the round trip time (RTT) of the UWB signals transmitted back and forth between the devices. For example, FIG. 1 illustrates an example sequence of UWB transmissions to determine the distance between a user device and an anchor device. A user device 102 can transmit a first UWB signal 113A over UWB link 113 to anchor device 104, receive a first UWB response signal 113B back from the anchor device 104 over UWB link 113, and calculate a distance between the UE 102 and the anchor device 104 based on a measurement of the RTT of the first UWB signal 113A and first UWB response signal 113B. That is, the user device 102 can calculate RTT as T1+T2+T3, where T1 is the amount of time it takes for the first UWB signal 113A to be sent from a transmitter of the user device 102 to a receiver of the anchor device 104, T2 is the amount of time it takes for the anchor device 104 to generate a reply, and T3 is the time duration in which a transmitter of the anchor device 104 sends the first UWB response signal 113B (as the reply) back to a receiver of the user device 102. Then, the user device 102 can calculate the distance as ½ of c×(RTT−T2), where c is the speed of light.

The user device 102 can be equipped with multiple antennas to determine not only the distance between the devices 102, 104 but also the direction of the anchor device 104, so that the user device 102 can determine its location based on the distance and direction. For example, the user device 102 may determine the direction of the anchor device 104 by receiving the first UWB response signal 113B at each of its antennas, where the antennas are located at different positions within the user device 102. The user device 102 may then determine the direction of arrival of the first UWB response signal 113B based on a time difference at which each of the antennas received the first UWB response signal 113B.

However, to locate a user in this manner, the user needs to have a proximate user device. In some scenarios, such as when the user is at home the user may put their user device away or walk away from their user device.

### SUMMARY

To determine a user's location without the user having to carry their user device with them everywhere they go, a tagless positioning system includes multiple anchor devices that continuously or periodically transmit UWB signals from one anchor device to another. For example, a first anchor device may continuously or periodically transmit UWB signals which are received at a second anchor device within the same building or room as the first anchor device. The UWB signals may be coded impulse signals and the second anchor device analyzes the received coded impulse signal to determine or reconstruct a channel impulse response (CIR) of the coded impulse signal. Typically, if there are no objects between the first and second anchor devices, the CIR includes a first pulse having the largest amplitude followed by subsequent pulses having smaller amplitudes. However, if there is a human in the field of view (FOV) of the first anchor device, the transmission and reflection coefficients of the CIR will change, resulting in a CIR that includes larger amplitudes and/or pulse durations for subsequent pulses than in a CIR when there are no objects between the first and second anchor devices. Accordingly, the second anchor device or a computing device that receives the CIR from the second anchor device can analyze the characteristics of the CIR to determine whether there is a user in the FOV of the first anchor device.

For example, the tagless positioning system may train a machine learning model with a first set of CIRs when there are no objects between the first and second anchor devices and a second set of CIRs when there is a user in the FOV of the first anchor device. Then the tagless positioning system may provide characteristics of a CIR to the machine learning model to determine whether there is a user in the FOV of the first anchor device.

Additionally, to determine the user's particular indoor location within a room or building, the tagless positioning system automatically calibrates when the user is using their user device. While the user is using their user device, the user walks around to various locations within the room or building. The user device can determine its location based on the RTT and/or the direction of arrival of UWB signals from the first anchor device. The second anchor device may store CIRs corresponding to each of the user's locations, so that the tagless positioning system has a mapping of user locations to CIR data.

Then when the user does not have their user device with them, the tagless positioning system can determine the user's location by comparing the CIR to the stored CIRs mapped to user locations. The tagless positioning system may determine the user's location as the location mapped to a stored CIR which matches the closest to the received CIR. In other implementations, the tagless positioning system may determine the user's location by assigning weights to each stored CIR, such that the sum of the weighted stored CIRs match the received CIR. Then the tagless positioning system may apply those same weights to the coordinates of the mapped locations and may combine the weighted, mapped location coordinates to determine the coordinates of the user's location.

The tagless positioning system may include n anchor devices within the same building or room continuously or periodically transmitting n×(n−1) UWB signals between each other. The n anchor devices may analyze the n×(n−1) UWB signals to determine or reconstruct n×(n−1) CIRs. In other implementations, a host anchor device or a server device may receive the n×(n−1) UWB signals and determine or reconstruct n×(n−1) CIRs. Then the host anchor device or the server device may compare the n×(n−1) CIRs to the stored CIRs mapped to user locations to determine the user's location.

In this manner, the tagless positioning system can determine a user's location without using a user device and/or without the user having a proximate user device. Additionally, by automatically calibrating the tagless positioning system, the user does not have to manually input their locations or travel to several preset locations, which can be time consuming and tedious. Instead, the tagless positioning system calibrates automatically as the user goes about their typical day while carrying their user device.

The location may be used to activate smart lights in the same room as the user, to adjust heating or air conditioning settings at the user's location, to adjust security settings at the user's location, etc.

An example embodiment of these techniques is a method for determining a location of a user. The method includes automatically calibrating a positioning system by transmitting communication signals between at least two anchor devices and a user device to determine and store locations of a user with channel impulse responses of the communication signals for each location. The method also includes receiving, at a first anchor device at a first fixed location within the positioning system, a communication signal transmitted by a second anchor device at a second fixed location within the positioning system. The user is not using the user device. The method also includes determining, by the first anchor device, a channel impulse response of the communication signal, and determining a location of the user within the positioning system by comparing the channel impulse response of the communication signal to the stored channel impulse responses and corresponding stored locations.

Another example embodiment of these techniques is a positioning system for determining a location of a user. The system includes a first anchor device at a first fixed location within the positioning system, and a second anchor device at a second fixed location within the positioning system. The first and second anchor devices are configured to in a first instance, automatically calibrate the positioning system by transmitting communication signals between the first and second anchor devices and a user device to determine locations of a user, and in a second instance, transmit, by the first anchor device, a communication signal received at the second anchor device, where the user is not using the user device. The system also includes a computing device including one or more processors, and a computer-readable memory, which is optionally non-transitory, coupled to the one or more processors and storing instructions thereon. The instructions, when executed by the one or more processors, cause the computing device to store the locations and corresponding channel impulse responses of the communication signals, determine a channel impulse response of the received communication signal, and determine a location of the user within the positioning system by comparing the channel impulse response of the communication signal to the stored channel impulse responses and corresponding stored locations.

Yet another example embodiment of these techniques is a computing device for determining a location of a user. The computing device includes one or more processors, and a computer-readable memory, which is optionally non-transitory, coupled to the one or more processors and storing instructions thereon. The instructions, when executed by the one or more processors, cause the computing device to automatically calibrate a positioning system by obtaining indications of locations of a user and corresponding channel impulses responses of communication signals received at anchor devices, and store the locations and corresponding channel impulse responses of the communication signals. The instructions also cause the computing device to receive an indication of a communication signal transmitted by a first anchor device to a second anchor device when the user is not using a user device, determine a channel impulse response of the communication signal, and determine a location of the user within the positioning system by comparing the channel impulse response of the communication signal to the stored channel impulse responses and corresponding stored locations.

### BRIEF DESCRIPTION OF THE DRAWINGS

FIG. 1 is an example message sequence that can be performed by the tagless positioning system for measuring a round trip time of messages exchanged between a user device and an anchor device;

FIG. 2 is an example channel impulse response of a communication signal which may be transmitted from one anchor device to another anchor device;

FIG. 3 illustrates a side-by-side comparison of two different channel impulse responses of communication signals transmitted from a first anchor device to a second anchor device when the room is empty and when there is a person in the room;

FIG. 4 is a schematic diagram of the software components for detecting whether there is a person in the room based on the channel impulse response;

FIG. 5 is a block diagram of an example tagless positioning system illustrating the components and parameters for automatically calibrating the tagless positioning system;

FIG. 6 is a block diagram of an example calibrated tagless positioning system illustrating the components and parameters for determining the location of a tagless user who is not using or is not proximate to a user device; and

FIG. 7 is a flow diagram of an example method for determining a location of a user, which can be implemented in a computing device.

### DETAILED DESCRIPTION OF THE DRAWINGS

Generally speaking, the techniques of this disclosure allow anchor devices to communicate with each other using a radio technology that is suitable for short-range communications, and/or high-bandwidth communications over a large portion of a radio spectrum. In some implementations, a user device may also communicate with the anchor devices during a calibration phase to determine locations of the user based on round trip times of communication signals transmitted back and forth between the user device and the anchor devices. A computing device may then map locations of the user to channel impulse responses of communication signals transmitted when the user is at each location. In other implementations, the anchor devices and/or user device may communicate with each other using any suitable radio technology.

One such non-limiting radio technology is ultra-wideband (UWB). The user device and anchor devices can be located in an indoor environment (i.e., in a building, such as a home, mall, sports arena, museum, theme park, tent, gazebo, canopy, or any suitable indoor environment in which at least a portion of the environment is located indoors) or an outdoor environment. In some implementations, the anchor devices may be included within a positioning system (also referred to herein as a “tagless positioning system”). The tagless positioning system may be an indoor positioning system or an outdoor positioning system. When the anchor devices are located in an indoor environment, the user's location may be an indoor location. When the anchor devices are located in an outdoor environment, the user's location may be an outdoor location.

When the user device communicates signals with the anchor devices over UWB for example during the calibration phase, the user device can determine its location relative to the anchor devices based on a measurement of the time of flight of those signals. Further, if the location of each of the anchor devices is known, the user device can determine its absolute location. Compared to conventional GPS-based location determination techniques, the user device is able to determine its location within the indoor environment with sub-meter accuracy. The user device may be a smart phone, a tablet computer, a laptop computer, a desktop computer, a wearable device such as a smart watch or smart glasses, or any suitable client computing device.

Furthermore, after the calibration phase, the anchor devices may communicate signals with each other over UWB, for example without communicating with a user device. Then the anchor devices may determine channel impulse responses of the received communication signals by for example, comparing a received communication signal to a template coded impulse signal to reconstruct the channel impulse response. The anchor devices may then transmit the channel impulse responses to a host anchor device or a network server for analyzing the channel impulse responses to detect the presence of a user and/or determine the specific indoor location of a user. In other implementations, the anchor devices transmit the raw communication signals to the host anchor device or the network server which compares each received communication signal to a template coded impulse signal to reconstruct channel impulse responses. The host anchor device may be one of the anchor devices transmitting and receiving communication signals in the positioning system.

A tagless user, as used herein, may refer to a user who is not using or is not proximate to a user device. For example, the user may be at their home and their user device may be charging in another room or the user may have placed their user device on a table, desk, or other location away from the user.

To determine the RTT of the UWB signals transmitted back and forth between devices, an anchor device typically determines the time it received a communication signal as the time when the amplitude of the communication signal exceeds a threshold amplitude. The anchor device may use a first-bounce estimation procedure to determine the time the anchor device received the communication signal, which may be referred to as a first path time.

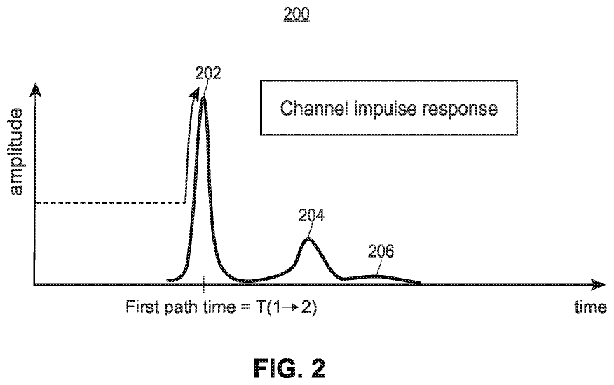

FIG. 2 illustrates an example channel impulse response 200 of a communication signal which may be transmitted from one anchor device to another anchor device. The graph shown in FIG. 2 is a waveform of the amplitude of the CIR 200 as a function of time. As mentioned above, a communication signal may be a coded impulse signal which may include a series of pulses encoded with a positive amplitude, negative amplitude, or no amplitude. The CIR may include a first pulse 202 having a peak amplitude above a threshold followed by a series of subsequent pulses 204, 206 having smaller peak amplitudes and/or longer pulse durations. In addition to the first path time, the CIR may include multipath information for the subsequent pulses 204, 206, such as the times of the subsequent pulses 204, 206, the peak amplitudes of the subsequent pulses 204, 206, the pulse durations of the subsequent pulses 204, 206, and/or other characteristics of the subsequent pulses 204, 206.

The waveform exhibited in the CIR 200 as shown in FIG. 2 may occur when there are no objects in the field of view of the anchor device transmitting the coded impulse signal. On the other hand, when there is an object such as a person in the field of view of the anchor device, the reflection and transmission coefficients of the waveform may change. This may cause the characteristics of the subsequent pulses 204, 206 of the CIR to change, and have larger amplitudes, longer pulse durations, etc.

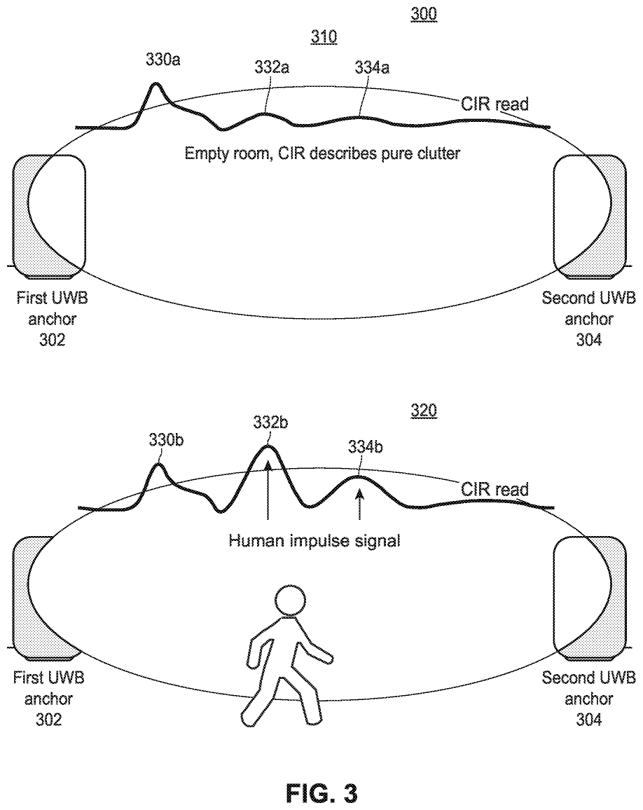

FIG. 3 illustrates a side-by-side comparison 300 of two different CIRs 310, 320 of communication signals transmitted from a first anchor device 302 to a second anchor device 304 when the room is empty 310 and when there is a person in the room 320. As shown in the side-by-side comparison 300, the peak amplitude and pulse characteristics of the respective first pulses 330a, 330b of the CIRs 310, 320 appear to be very similar if not the same. On the other hand, the peak amplitude of the subsequent pulse 332b for the CIR 320 when there is a person in the room is significantly larger than the peak amplitude of the subsequent pulse 332a for the CIR 310 when the room is empty. Additionally, the peak amplitude of the second subsequent pulse 334b for the CIR 320 when there is a person in the room is also significantly larger than the peak amplitude of the second subsequent pulse 334a for the CIR 310 when the room is empty. The pulse durations of the subsequent pulses 332b, 334b for the CIR 320 when there is a person in the room also appears to be different from the pulse durations of the subsequent pulses 332a, 334a for the CIR 310 when the room is empty.

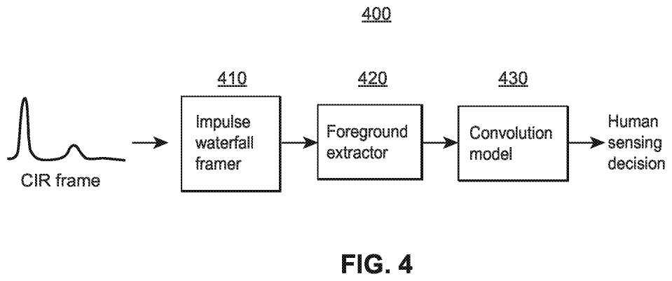

In this manner, the tagless positioning system may analyze characteristics of the CIRs 310, 320 to detect whether there is a person in the field of view of one of the anchor devices in the tagless positioning system. FIG. 4 illustrates a schematic diagram 400 of the software components 410-430 for detecting whether there is a person in the room based on the channel impulse response. The software components 410-430 may be included in a host anchor device which obtains CIRs from communication signals received at the host anchor device, and CIRs from communication signals received at other anchor devices. The CIRs may also correspond to communication signals transmitted at different times, on different days, etc. In other implementations, the software components 410-430 may be included in a network server which obtains the CIRs from communication signals received at anchor devices.

In any event, an impulse waterfall framer 410 in the host anchor device or network server may receive multiple CIRs obtained at a particular anchor device over time, for example as a user enters a room with the particular anchor device in it. The impulse waterfall framer 410 may then generate a two-dimensional matrix of the CIR data for the multiple CIRs, which may be referred to herein as an impulse waterfall. Each column in the impulse waterfall may be a different CIR, where each row represents the amplitude of the CIR at a particular point in time, time range, or time bin relative to the time in which pulse data for the CIR first was received.

For example, the first row may be for a first time bin when a first pulse was received, the second row may be for a second time bin when a second pulse was received, and the third row may be for a third time bin when a third pulse was received all within the same CIR. In other implementations, the time bins may be smaller and the first three rows may be for time bins when the first pulse was received, for example as the amplitude of the first pulse was rising, at the peak of the amplitude of the first pulse, and as the amplitude of the first pulse was declining. The first column may be for a first CIR obtained when the user has not yet entered the room. The second column may be for a second CIR obtained as the user enters the room. The third column may be for a third CIR obtained as the user is in the room, etc. In this manner, each row illustrates a comparison of the amplitudes of CIRs at a particular point in time, time range, or time bin which may indicate a variation in the transmissive coefficient or amplitude over time as the user approaches the field of view of the anchor device.

Then the host anchor device or network server applies the impulse waterfall to a foreground extractor 420 similar to a Gaussian mixture model in computer vision to identify clusters of the CIRs, where each cluster shares common characteristics. The host anchor device or network server then buffers the foreground waterfall for a threshold time period (˜2 seconds) and passes the buffered foreground waterfall to a convolutional neural network 430 that completes the final decision of human perception. The convolutional neural network 430 may be a binary classification model trained to detect whether or not a foreground waterfall indicates the presence of a person.

For example, the convolutional neural network 430 may be trained with a first set of foreground waterfalls from when a human was present in the field of view of an anchor device and a second set of foreground waterfalls from when a human was not present in the field of view of an anchor device. The host anchor device or the network server may generate the convolutional neural network 430 by analyzing characteristics (e.g., pulse amplitudes, pulse amplitude differentials at various time bins, etc.) of the first set of foreground waterfalls and characteristics of the second set of foreground waterfalls. The host anchor device or the network server may apply characteristics of the buffered foreground waterfall to the trained convolutional neural network 430 to identify whether or not a human is in the field of view of the anchor device.

In some implementations, the tagless positioning system may identify not only whether or not a human is in the field of view of the anchor device, but may identify a particular user of multiple candidate users. For example, for each user, the host anchor device or the network server may train the convolutional neural network 430 with a different set of foreground waterfalls from when the particular user was present in the field of view of an anchor device. The host anchor device or the network server may then adjust the convolutional neural network 430 by analyzing characteristics of each different set of foreground waterfalls corresponding to each different user.

As a result, the convolutional neural network 430 may include a user signature for each user which may be identified during a calibration phase based on characteristics of CIRs received when the particular user is using a user device. In some implementations, the convolutional neural network 430 may be a deep neural network with at least a first layer of hidden nodes for determining whether or not a human is in the field of view of the anchor device, and at least a second layer of hidden nodes for determining which user of multiple candidate users is in the field of view of the anchor device. The host anchor device or the network server may then apply characteristics of the buffered foreground waterfall to the convolutional neural network 430 to determine whether or not a human is in the field of view of the anchor device, and which user is in the field of view of the anchor device.

While the CIR data may be used to detect the presence of a user in the field of view of an anchor device, to determine the user's particular indoor location within a room or building, the tagless positioning system automatically calibrates when the user is using their user device. The user device can determine its location based on the RTT and/or the direction of arrival of UWB signals from anchor device(s). At the same time as the user device determines its location, the anchor devices may receive CIRs from communication signals transmitted by the anchor devices. The host anchor device or the network server may then store the CIRs corresponding to each of the user's locations, so that the tagless positioning system has a mapping of user locations to CIR data.

### Calibration Phase

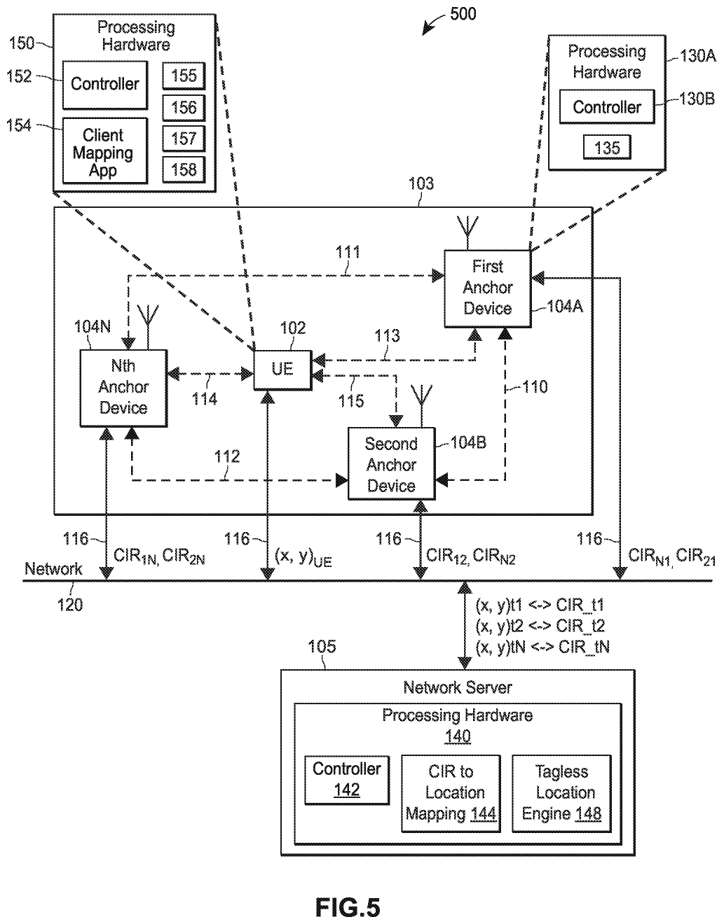

FIG. 5 is a block diagram of an example tagless positioning system 500 illustrating the components and parameters for automatically calibrating the tagless positioning system 500. The tagless positioning system 500 includes a user device 102 (also referred to herein as a “user equipment (UE)”), as well as a first anchor device 104A, a second anchor device 104B, and an nth anchor device 104N, each communicatively coupled to a network server 105 via a network 120. The network 120 in general can include one or more wired and/or wireless communication links (e.g., communication links 116) and may include, for example, a wide area network (WAN) such as the Internet, a local area network (LAN), a cellular telephone network, or another suitable type of network.

The user device can be in range to communicate over UWB with one or more of the anchor devices 104A, 104B, 104N that are spatially-separated and located in an indoor environment 103 (e.g., a building). For example, the first anchor device 104A may be at a first fixed location within the tagless positioning system 500, the second anchor device 104B may be at a second fixed location within the tagless positioning system 500, the nth anchor device 104N may be at an nth fixed location within the tagless positioning system 500, etc. The anchor devices 104A, 104B, 104N themselves can be in range to communicate over UWB amongst each other, and to the network server 105. In other implementations, the anchor devices 104A, 104B, 104N may be located in an outdoor environment.

Although a single user and three anchor devices are illustrated in the example tagless positioning system 500, generally speaking, the tagless positioning system 500 can include m user devices and n anchor devices, where both m and n are equal to or greater than one. Although the examples disclosed herein refer specifically to specific radio technology (UWB), in general the techniques of this disclosure can also apply to other suitable radio technologies for short-range, high-bandwidth communications over a large portion of a radio spectrum or for any suitable radio technologies.

Each of the anchor devices 104A, 104B, 104N can be any suitable type of computing device capable of wireless communications, such as a home assistant device (e.g., Google Home, Google Nest, Amazon Echo), a tablet computer, a wireless hotspot, a femtocell, or a broadband router. The anchor device 104A includes processing hardware 130A, which can include one or more general-purpose processors (e.g., central processing units (CPUs)) and a computer-readable memory (e.g., random access memory (RAM), flash memory, read-only memory (ROM)) storing machine-readable instructions executable on the one or more general-purpose processor(s), and/or special-purpose processing units.

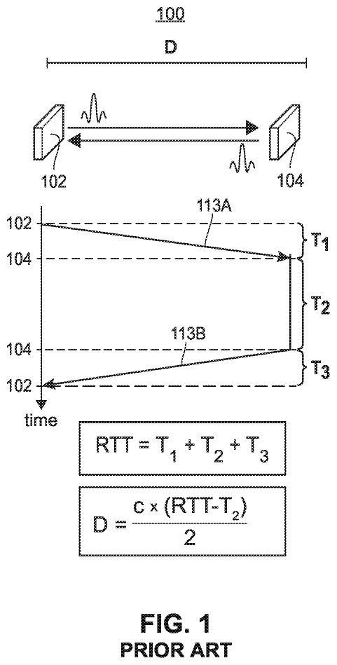

The processing hardware 130A in the example implementation in FIG. 1A includes a controller 132A that is configured to transmit and receive communication signals, such as coded impulse signals. For example, the controller 132A can transmit a first UWB signal which is received at the user device 102 (ref. no. 113) and a second anchor device 104B (ref. no. 110). The controller 132 can then receive a first UWB response signal 113 from the user device 102, and calculate a distance between the first anchor device 104A and the user device 102 based on a measurement of the RTT of the first UWB signal and the first UWB response signal. That is, the controller 132A can calculate RTT as T₁+T₂+T₃, where T₁ is the amount of time it takes for the first UWB signal to be sent from a transmitter (e.g., controller 132A) of the first anchor device 104A to the user device 102, T₂ is the amount of time it takes for the user device to generate a reply, and T₃ is the time duration in which a transmitter of the user device sends the first UWB response signal (as the reply) back to a receiver (e.g., controller 132A) of the first anchor device 104A. Then, the controller 132A can calculate the distance as ½ of c×(RTT−T₂), where c is the speed of light.

Additionally, the controller 132A may receive a communication signal from another anchor device 104B, 104N, such as a coded impulse signal. The controller 132A may compare the coded impulse signal to a template coded impulse signal for communication signals transmitted by the other anchor device 104B, 104N to reconstruct a CIR for the communication signal. The controller 132A may receive communication signals 110, 111 from each of the anchor devices 104B, 104N and reconstruct CIRs for each of the received communication signals. The controller 132A may also transmit communication signals 110, 111, 113 to each of the anchor devices 104B, 104N and to the user device 102.

The processing hardware 130A can also include a network interface 135. The network interface 135 can include one or more communication interfaces such as hardware, software, and/or firmware for enabling communications with the network server 105 via a cellular network, a WiFi network, or any other suitable network such as the network 120. For example, using the network interface 135, the first anchor device 104A can send the distance to the network server 105 or to one of the anchor devices 104A-104N, such as a host anchor device that analyzes the distance measurements to determine the location of the user device and stores CIRs obtained when the user is at a particular location to map CIRs to the particular location. The host anchor device may be one of the anchor devices 104A-104N that performs additional processing along with facilitating distance measurements and CIR measurements. For example, the host anchor device may determine the location of the user device 102 based on the distance measurements, may map CIRs to particular locations for the user, and may determine the location of a user without a user device 102 by comparing CIR data to the stored CIRs and corresponding locations. The host anchor device may include similar processing hardware and software components as the network server 105 in addition to transmitting and receiving communication signals.

Although not shown, anchor devices 104B, 104N can include processing hardware similar to processing hardware 130A. As such, using UWB links any one of the anchor devices 104B, 104N can also measure a distance to the user device, obtain CIRs from other anchor devices 104A-104N and send such measurements and CIRs to the network server 105, in a similar manner as described above. More generally, if there are n anchor devices, a total of n distance measurements are determined between the n anchor devices and the user device. The anchor devices 104A-104N may transmit each of the n distance measurements to a host anchor device (e.g., first anchor device 104A) or may transmit the distance measurements to the network server 105. Additionally, if there are n anchor devices, a total of n×(n−1) CIRs (e.g., CIR_{1->N}, CIR_{2->N}, CIR_{1->2}, CIR_{N->2}, CIR_{N->1}, CIR_{2->1}) may be received at the n anchor devices. The anchor devices 104A-104N may transmit each of the CIRs to a host anchor device (e.g., first anchor device 104A) or may transmit the CIRs to the network server 105.

The network server 105 can be any suitable type of computing device capable of communicating with each of the anchor devices 104A-104N, as well as the user device 102, over the network 120. The network server 105 includes processing hardware 140, which can include one or more general-purpose processors (e.g., CPUs) and a computer-readable memory (e.g., RAM, flash memory, ROM) storing machine-readable instructions executable on the one or more general-purpose processor(s), and/or special-purpose processing units. The processing hardware 140 in the example implementation in FIG. 5 includes a controller 142 that is configured to receive, over communication links 116 via the network 120, CIRs (e.g., CIR_{1->N}, CIR_{2->N}, CIR_{1->2}, CIR_{N->2}, CIR_{N->1}, CIR_{2->1}) from anchor devices 104A-104N. The processing hardware 140 can also receive, over communication links 116 via the network 120, the location of the user device 102 (e.g., (x, y)_{UE}) or distances from each of the anchor devices to the user device 102 to determine the location of the user device 102.

In other implementations, the functionality performed at the network server 105 may be performed at the host anchor device. Additionally or alternatively, the functionality performed at the host anchor device may be performed at the network server 105 and/or a combination of the network server 105 and the host anchor device may perform the functionality to determine locations of the user device 102, map the locations to CIRs, and determine a location of a user without a user device 102 based on a CIR of a communication signal transmitted when the user is within a field of view of an anchor device 104A-104N and the stored CIRs and their mappings to user locations. For example, the host anchor device may house the processing hardware 140.

The user device 102 includes processing hardware 150, which can include one or more general-purpose processors (e.g., CPUs) and a computer-readable memory (e.g., RAM, flash memory, ROM) storing machine-readable instructions executable on the general-purpose processor(s), and/or special-purpose processing units. The processing hardware 150 in the example implementation of FIG. 5 includes a controller 152 that is configured to determine a distance between the UE 102 and any one of the anchor devices 104A-104N included in the tagless positioning system 500 based on a measurement of the time of flight associated with a signal exchanged between them.

For example, the controller 152 can transmit a first UWB signal 113 over a UWB link to the first anchor device 104A, receive a first UWB response signal 113 back from the first anchor device 104A over UWB link 113, and calculate a distance between the user device 102 and the first anchor device 104A based on a measurement of the RTT of the first UWB signal 113 and first UWB response signal 113. That is, the controller 152 can calculate RTT as T₁+T₂+T₃, where T₁ is the amount of time it takes for the first UWB signal 113 to be sent from a transmitter (e.g., controller 152) of the user device 102 to a receiver (e.g., controller 132A) of the first anchor device 104A, T₂ is the amount of time it takes for the first anchor device 104A (e.g., controller 132A) to generate a reply, and T₃ is the time duration in which a transmitter (e.g., controller 132A) of the first anchor device 104A sends the first UWB response signal 113 (as the reply) back to a receiver (e.g., controller 152) of the user device 102. Then, the controller 152 can calculate the distance between the user device 102 and the first anchor device 104A as ½ of c×(RTT−T₂), where c is the speed of light.

In some implementations, the user device 102 can be equipped with multiple antennas to determine not only the distance but also the direction of the first anchor device 104A, so that the controller 152 can determine the location ((x, y)_{UE}) of the user device 102 based on the distance and direction. For example, the user device 102 may determine the direction of the first anchor device 104A by receiving the first UWB response signal 113 at each of its antennas, where the antennas are located at different positions within the user device 102. The user device 102 may then determine the direction of arrival of the first UWB response signal 113 based on a time difference at which each of the antennas received the first UWB response signal 113. In some implementations, the user device 102 may include a compass, magnetometer, gyroscope, accelerometer, and/or other sensors to determine its orientation. Then the user device 102 may determine the direction of arrival of the first UWB response signal 113 based on a time difference at which each of the antennas received the first UWB response signal 113 and based on the orientation of the user device 102.

In other implementations, the first anchor device 104A or any of the anchor devices 104A-104N can be equipped with multiple antennas for determining the direction of the user device 102 relative to the anchor device 104A-104N, so that the controller 132A can determine the location ((x, y)_{UE}) of the user device 102 based on the distance and direction. For example, the first anchor device 104A may transmit the first UWB signal 113 which is received at the user device 102. The user device 102 may then transmit the first UWB response signal 113 which is received at multiple antennas at the first anchor device 104A. The first anchor device 104A may then determine the direction of arrival of the first UWB response signal 113 based on a time difference at which each of the antennas received the first UWB response signal 113. Then the first anchor device 104A can determine the location of the user device 102 based on the distance and direction of the user device 102 from the first anchor device 104A.

In some implementations, the controller 152 can determine the location ((x, y)_{UE}) of the user device 102 based on the distances to the respective anchor devices 104A-104N. For instance, in addition to determining the distance to the first anchor device 104A described above, the controller 152 can transmit second and third UWB signals over respective UWB links 114, 115 to respective anchor devices 104B and 104N, receive the second and third UWB response signals over the respective UWB links 114, 115 back from the respective anchor devices 104B and 104C, and calculate distances to the respective anchor devices 104B and 104C, similar to the manner in which the controller 152 can calculate the distance to the first anchor device 104A as described above.

Using the distances to each of the anchor devices 104A-104N, the relative location of the user device 102 can be determined utilizing trilateration techniques as known in the art. Generally speaking, if n is equal to or greater than 2, the relative location ((x, y)_{UE}) of the user device 102 can be determined utilizing multilateration techniques as known in the art.

When n is equal to 3, the location of the user device 102 can be determined in 2 dimensions (i.e. a floor on which the anchor devices are located). When n is greater or equal to 4, the location of the user device can be determined in 3 dimensions, for example to determine the UE location in a multi-story building.

As mentioned above, during the calibration phase, the user may walk around rooms in their home or building as the tagless positioning system automatically calibrates by determining locations of the user device 102 and mapping the locations to corresponding CIRs. The user does not have to manually input their locations or travel to several preset locations.

In some implementations, the processing hardware 140 of the network server 105 or the host anchor device can include a CIR to Location Mapping 144. For each user, the CIR to Location Mapping 144 stores locations of the user (which may be indoor locations) and CIR(s) corresponding to the location. For example, at a first point in time a user may be located at location (x, y)t₁. The CIR to Location Mapping 144 may store a single CIR (CIR_t₁) received at one of the anchor devices 104A-104N at the time the user was at location (x, y)t₁ (e.g., (x, y)t₁<->CIR_t₁). In other implementations, the CIR to Location Mapping 144 may store an array of CIRs (e.g., CIR_t_{1_1->N}, CIR_t_{1_2->N}, CIR_t_{1_1->2}, CIR_t_{1_N->2}, CIR_t_{1_N->1}, CIR_t_{1_2->1}) received at one of the anchor devices 104A-104N at the time the user was at location (x, y)t₁.

For each user, the CIR to Location Mapping 144 may store a different set of locations (which may be indoor locations) and CIR(s) corresponding to the locations. Accordingly, the tagless positioning system 500 may first detect the presence of a user, then identify the particular user via a user signature as mentioned above, and then apply the set of locations and CIR(s) corresponding to each location specific to the identified user to determine the location of the user.

By storing an array of CIRs corresponding to a particular location of the user, the tagless positioning system 500 can more accurately determine a user's location compared to using a single CIR received at a single anchor device and mapping the single CIR to the particular location. For example, a CIR received at the single anchor device 104A (after the calibration phase when the user does not have their user device 102) may be similar to the stored CIR for the anchor device 104A. However, CIRs received at other anchor devices 104B-104N may be very different from the stored CIRs for the respective anchor devices 104N-104N. As a result, using multiple CIRs received at multiple anchor devices 104A-104N, the tagless positioning system is less likely to falsely identify the user's location.

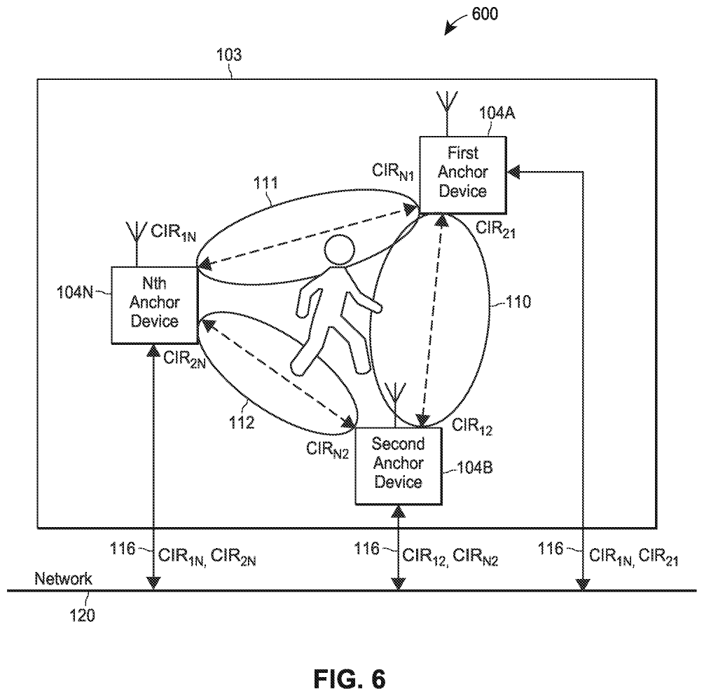

The processing hardware 140 of the network server 105 or the host anchor device may also include a tagless location engine 148, described in more detail below with reference to FIG. 6.

The processing hardware 150 in the example implementation of FIG. 5 can include a network interface 155, a user interface 156, an input/output (I/O) interface 157, and an operating system (OS) 158. The network interface 155 can include one or more communication interfaces such as hardware, software, and/or firmware for enabling communications with the network server 105 via a cellular network, a WiFi network, or any other suitable network such as the network 120. For example, the controller 152 can receive the locations of the respective anchor devices 104A-104N as determined by the network server 105. Using the distances and locations of the respective anchor devices 104A-104N. the user device 102 can utilize trilateration techniques as known in the art to determine its absolute location. As another example, the controller 152 can transmit the (x, y)_{UE} to the network server 105 over communication links 116 via the network 120, so that the network server 105 can track the location of the user device 102.

The user interface 156 can include one or more input devices configured to receive user commands, such as a touchscreen, a keyboard, a mouse, microphone, a camera, etc. and one or more output devices configured to provide visual, audio, and/or tactile output, such as touchscreen or a speaker. The OS 158 can be any suitable mobile or general-purpose OS. In addition, the processing hardware 150 can store one or more applications that communicate (e.g., transmitting data, receiving data, or both) data via the network 120, including a client mapping application 154, which will be described in further detail below. The OS 158 may include application programming interface (API) functions that allow applications to access information from components of the user device 102. The user device 102 may also include components not shown in FIG. 5, such as a graphics processing unit (GPU).

### Tagless User Device Phase

After the tagless positioning system 500 has been calibrated which may take hours, days, etc., the tagless positioning system 500 can determine the location of a user when the user is not using or is not proximate to their user device 102. FIG. 6 is a block diagram of an example calibrated tagless positioning system 600 illustrating the components and parameters for determining the location of a tagless user who is not using or is not proximate to a user device 102.

As shown in FIG. 6, the first anchor device 104A transmits communication signals 110, 111 to the second anchor device 104B and the nth anchor device 104N, respectively resulting in the second anchor device 104B receiving CIR₁₂ and the nth anchor device 104N receiving CIR_{1N}. The second anchor device 104B transmits communication signals 110, 112 to the first anchor device 104B and the nth anchor device 104N, respectively resulting in the first anchor device 104B receiving CIR₂₁ and the nth anchor device 104N receiving CIR_{2N}. The nth anchor device 104N transmits communication signals 111, 112 to the first anchor device 104B and the second anchor device 104B, respectively resulting in the first anchor device 104B receiving CIR_{N1} and the second anchor device 104B receiving CIR_{N2}. The user is in the fields of view 110-112 of each of the anchor devices 104A-104N.

In some implementations, the anchor devices 104A-104N transmit the CIRs to the host anchor device or the network server 105. Then the tagless location engine 148 in the host anchor device or the network server 105 analyzes the CIRs to determine the location of the user. First, the tagless location engine 148 may determine whether or not a user is present in the fields of view of the anchor devices 104A-104N, and which user of multiple candidate users is in the fields of view of the anchor devices 104A-104N. For example, the tagless location engine 148 may perform the steps 410-430 described above with reference to FIG. 4 to generate an impulse waterfall, apply the impulse waterfall to a foreground extractor 420 to generate a foreground waterfall, and apply the foreground waterfall to a convolutional neural network 430 to determine whether or not a user is present in the fields of view of the anchor devices 104A-104N, and to identify which user is present in the fields of view of the anchor devices 104A-104N according to user signatures from the CIR data.

In response to determining that a user is present in the fields of view of the anchor devices 104A-104N and identifying the particular user, the tagless location engine 148 may obtain a mapping of locations for the user (which may be indoor locations) and CIRs corresponding to each location from the CIR to Location Mapping 144.

For example, for a particular anchor device 104A, the tagless location engine 148 may obtain the following mapping: (x, y)t₁<->CIR_t₁, (x, y)t₂<->CIR_t₂. (x, y)t₃<->CIR_t₃ . . . (x, y)t_{N}<->CIR_t_{N}, where t₁, t₂, t₃ . . . t_{N} correspond to different locations at different times. The tagless location engine 148 obtains the CIR received at a particular anchor device 104A (e.g., CIR₂₁) and compares the CIR to the stored CIRs and corresponding locations to determine the location of the user, which may be an indoor location. More specifically, the tagless location engine 148 may assign weights to each of the stored CIRs, such that the sum of the combined, weight CIRs is equal to the CIR (e.g., CIR₂₁). For example, the weights may be represented as [w_1, w_2 . . . w_N]. The tagless location engine 148 may determine weights such that CIR≈w_1*CIR_1+w_2*CIR_2+ . . . +w_N*CIR_N to minimize the mean squared error in the difference between the two.

Then the tagless location engine 148 may assign the same weights to the corresponding locations, apply the weights to the coordinates for the locations, and combine the weighted coordinates to determine the coordinates of the location of the user as a weighted average of the coordinates. For example, the determined location of the user (x, y) may be determined as (w_1*(x, y)t₁+w_2*(x, y)t₂+ . . . +w_N*(x, y)t_{N}).

The tagless location engine 148 may repeat this process for each CIR received at each anchor device 104A-104N and may compare the determined locations for each CIR to each other. In some implementations, the tagless location engine 148 may combine the determined locations for each CIR in any suitable manner to make a final determination of the location of the user. For example, the tagless location engine 148 may average the coordinates of each of the determined locations to make a final determination of the location. In other implementations, the tagless location engine 148 may cluster the determined locations and assign votes to each cluster based on the number of locations in each cluster. Then the cluster with the highest vote total may be used to make the final determination. For example, the tagless location engine 148 may discard the other clusters and may average the coordinates of each of the determined r locations in the cluster with the highest vote total to make the final determination of the location.

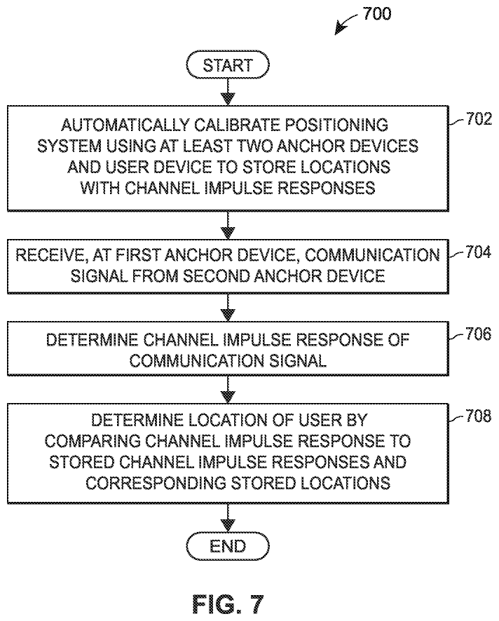

FIG. 7 illustrates a flow diagram of an example method 700 for determining a location of a user. The method 700 can be implemented in a set of instructions stored on a computer-readable memory and executable at one or more processors of a host anchor device 104A, a network server 105, another anchor device 104B, or any suitable combination of these.

At block 702, during a calibration phase, the host anchor device may automatically calibrate the positioning system 500 using at least two anchor devices 104A, 104B and a user device 102 of a user to store locations of the user with corresponding CIRs, where each CIR is received at the time the user is located at a corresponding location. The locations may be indoor locations.

For example, a first anchor device 104A can transmit a first UWB signal which is received at the user device 102 (ref. no. 113) and a second anchor device 104B (ref. no. 110). The first anchor device 104A can then receive a first UWB response signal 113 from the user device 102, and calculate a distance between the first anchor device 104A and the user device 102 based on a measurement of the RTT of the first UWB signal and the first UWB response signal. Then, the first anchor device 104A can calculate the distance as ½ of c×(RTT−T2), where c is the speed of light.

In some implementations, the first anchor device 104A can be equipped with multiple antennas for determining the direction of the user device 102 relative to the anchor device, so that the first anchor device 104A can determine the location ((x, y)_{UE}) of the user device 102 based on the distance and direction. In other implementations, the user device 102 determines its own location ((x, y)_{UE}) based on distances to the anchor devices 104A-104N using trilateration techniques, or the host anchor device receives each of the distances to the user device 102 from the anchor devices 104A-104N and determines the location of the user device 102 based on the distances using trilateration techniques.

Additionally, the first anchor device 104A may receive a communication signal from another anchor device 104B, 104N, such as a coded impulse signal. The first anchor device 104A may compare the coded impulse signal to a template coded impulse signal for communication signals transmitted by the other anchor device 104B, 104N to reconstruct a CIR for each communication signal.

The host anchor device may then receive the locations of the user and the corresponding CIRs from each of the anchor devices 104A-104N received when the user was at a particular location, and may store the locations mapped to the CIRs. For example, the host anchor device may store a single CIR (CIR_t₁) received at one of the anchor devices 104A-104N at the time the user was at location (x, y)t₁ (e.g., (x, y)t₁<->CIR_t₁). In other implementations, the host anchor device may store an array of CIRs (e.g., CIR_t_{1_1->N}. CIR_t_{1_2->N}, CIR_t_{1_1->2}, CIR_t_{1_N->2}, CIR_t_{1_N->1}, CIR_t_{1_2->1}) received at one of the anchor devices 104A-104N at the time the user was at location (x, y)t₁. The host anchor device may store the mapping of CIRs to locations for the particular user, and may also store additional mappings of CIRs to locations for other users.

Additionally, the host anchor device may use the CIRs to train a machine learning model, such as the convolutional neural network 430 to identify the particular user of multiple candidate users. For example, the host anchor device may analyze characteristics of each different set of CIRs corresponding to each different user. As a result, the convolutional neural network 430 may include a user signature for each user.

Then after the positioning system 500 has been calibrated, at block 704, the first anchor device 104A may receive a communication signal from a second anchor device 104B. The first anchor device 104A may reconstruct the CIR for the communication signal (block 706), and may send the CIR to the host anchor device. In other implementations, the first anchor device 104A may send the raw communication signal and the host anchor device may reconstruct the CIR. Additionally, the first anchor device 104A may receive multiple communication signals from the second anchor device 104B continuously or periodically and may send the CIRs to the host anchor device. In some implementations, the first anchor device 104A may be the host anchor device.

The host anchor device may then analyze the CIR(s) to determine whether there is a user present in the field of view of the first anchor device 104A, and if so, identify the particular user of multiple candidate users. For example, the host anchor device may generate an impulse waterfall of CIRs obtained at the first anchor device 104A over time. The host anchor device may then apply the impulse waterfall to a foreground extractor 420 to generate a foreground waterfall, and apply the foreground waterfall to a convolutional neural network 430 to determine whether or not a user is present in the field of view of the first anchor device 104A, and to identify which user is present in the field of view of the first anchor device 104A according to user signatures from the CIR data.

In addition to analyzing the CIR(s) from the first anchor device 104A, the host anchor device may receive and analyze CIR(s) from each of the other anchor devices 104B, 104N to determine whether or not a user is present in the field of view of one of the other anchor devices 104B, 104N, and to identify which user is present in the field of view of the one of the other anchor devices 104B, 104N.

In response to identifying a user present in the field of view of one of the anchor devices 104A-104N, the host anchor device determines the location of the user (block 708), which may be an indoor location. More specifically, the host anchor device obtains a mapping of locations for the user and CIRs corresponding to each location which were received at each anchor device 104A-104N for example, from the CIR to Location Mapping 144.

The host anchor device then compares the CIR(s) to the stored CIRs and corresponding locations to determine the location of the user. More specifically, the host anchor device may assign weights to each of the stored CIRs, such that the sum of the combined, weight CIRs is equal to the CIR (e.g., CIR₂₁) received at a particular anchor device 104A and from a particular anchor device 104B. For example, the weights may be represented as [w_1, w_2 . . . w_N]. The host anchor device may determine weights such that CIR≈w_1*CIR_1+w_2*CIR_2+ . . . +w_N*CIR_N to minimize the mean squared error in the difference between the two.

Then the host anchor device may assign the same weights to the corresponding locations, apply the weights to the coordinates for the locations, and combine the weighted coordinates to determine the coordinates of the location of the user as a weighted average of the coordinates. For example, the determined location of the user (x, y) may be determined as (w_1*(x, y)t₁+w_2*(x, y)t₂+ . . . +w_N*(x, y)t_{N}).

The host anchor device may repeat this process for each CIR received at each anchor device 104A-104N (e.g., each of the n×(n−1) CIRs) and may compare the determined locations for each CIR to each other. In some implementations, the host anchor device may combine the determined locations for each CIR in any suitable manner to make a final determination of the location of the user. For example, the host anchor device may average the coordinates of each of the determined locations to make a final determination of the location. In other implementations, the host anchor device may cluster the determined locations and assign votes to each cluster based on the number of locations in each cluster. Then the cluster with the highest vote total may be used to make the final determination. For example, the host anchor device may discard the other clusters and may average the coordinates of each of the determined locations in the cluster with the highest vote total to make the final determination of the location.

In response to determining the location of the user, the host anchor device and/or the network server may perform a particular action. For example, the host anchor device and/or the network server 105 may transmit a control signal to smart lights in the area where the user is located to activate the smart lights. For example, the user may be in a particular corner of the living room and the host anchor device and/or the network server 105 may transmit a control signal to activate smart lights above the user. In another example, when the user is within a threshold distance of a television in the living room, the host anchor device and/or the network server 105 may transmit a control signal to turn on the television.

In yet another example, the host anchor device and/or the network server 105 may transmit control signals to adjust heating or air conditioning settings at the user's location. For example, as the user moves from room to room the host anchor device and/or the network server 105 may increase or decrease the temperature in the room that the user is in so that the user is comfortable. In another example, the host anchor device and/or the network server 105 may transmit control signals to adjust security settings at the user's location. For example, the host anchor device and/or the network server may automatically lock or unlock doors around the user's current location by communicating with a smart lock having automated locking and unlocking mechanisms.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms (e.g., controllers 132A, 142, 152). Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. As used herein “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The method 700 may include one or more function blocks, modules, individual functions or routines in the form of tangible computer-executable instructions that are stored in a computer-readable storage medium, which may be non-transitory, and executed using a processor of a computing device (e.g., a network server, a personal computer, a smart phone, a tablet computer, a smart watch, a mobile computing device, an anchor device, a home assistant device or other client computing device, as described herein). The method 700 may be included as part of any backend server (e.g., a network server or any other type of server computing device, as described herein), a host anchor device, a user device, or an anchor device of the example environment, for example, or as part of a module that is external to such an environment. Though the figures may be described with reference to the other figures for ease of explanation, the method 700 can be utilized with other objects and user interfaces. Furthermore, although the explanation above describes steps of the method 700 being performed by specific devices (such as a network server, a user device, a host anchor device, or an anchor device), this is done for illustration purposes only. The blocks of the method 700 may be performed by one or more devices or other parts of the environment.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

Still further, the figures depict some embodiments of the example environment for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a tagless positioning system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A method for determining a location of a user, the method comprising:
automatically calibrating a positioning system by transmitting communication signals between at least two anchor devices and a user device to determine and store locations of a user with channel impulse responses of the communication signals for each location;
receiving, at a first anchor device at a first fixed location within the positioning system, a communication signal transmitted by a second anchor device at a second fixed location within the positioning system, wherein the user is not using the user device;
determining, by the first anchor device, a channel impulse response of the communication signal; and
determining a location of the user within the positioning system by comparing the channel impulse response of the communication signal to the stored channel impulse responses and corresponding stored locations.

2. The method of claim 1, wherein automatically calibrating the positioning system includes:
for each transmitted communication signal from one of the at least two anchor devices:
receiving, at the anchor device, a response communication signal from the user device;
determining one of the locations based on a round trip time of the transmitted communication signal and the response communication signal;
receiving the transmitted communication signal at another of the at least two anchor devices;
determining a channel impulse response of the transmitted communication signal received at the other anchor device; and
storing the determined location with the determined channel impulse response.

3. The method of claim 1, wherein determining the location of the user by comparing the channel impulse response of the communication signal to the stored channel impulse responses and corresponding stored locations includes:
assigning a weight to each stored channel impulse response such that a sum of weighted, stored channel impulse responses produces the channel impulse response of the communication signal;
applying the weight assigned to each stored channel impulse response to the corresponding location stored for the channel impulse response; and
combining the weighted, stored locations to determine the location of the user.

4. The method of claim 1, further comprising:
identifying a user signature for the user during calibration based on characteristics of channel impulse responses for the communication signals transmitted when the user is using a user device;
storing the user signature for the user; and
determining that the channel impulse response corresponds to the user of a plurality of users by comparing the characteristics of the channel impulse response to the stored user signature.

5. The method of claim 1, wherein the communication signal is a coded impulse signal.

6. The method of claim 5, wherein determining the channel impulse response includes:
obtaining, at the first anchor device, a template coded impulse signal;
comparing, by the first anchor device, the template coded impulse signal to the received coded impulse signal to reconstruct the channel impulse response.

7. The method of claim 5, wherein the communication signal is a first communication signal, the channel impulse response is a first channel impulse response, and further comprising:
receiving, at the second anchor device, a second communication signal transmitted by the first anchor device;
determining a second channel impulse response of the second communication signal,
wherein comparing the channel impulse response of the communication signal to the stored channel impulse responses includes comparing the first and second channel impulses responses to the stored channel impulse responses and corresponding stored locations.

8. The method of claim 7, wherein receiving first and second communication signals at first and second anchor devices includes:
receiving, at n anchor devices, n×(n−1) communication signals from the n anchor devices; and
determining n×(n−1) channel impulse responses of the n×(n−1) communication signals,
wherein comparing the channel impulse response of the communication signal to the stored channel impulse responses includes comparing the n×(n−1) channel impulses responses to the stored channel impulse responses and corresponding stored locations.

9. The method of claim 7, wherein the positioning system is an indoor positioning system and the location of the user is an indoor location.

10. A positioning system for determining a location of a user, the system comprising:
a first anchor device at a first fixed location within the positioning system;
a second anchor device at a second fixed location within the positioning system;
wherein the first and second anchor devices are configured to:
in a first instance, automatically calibrate the positioning system by transmitting communication signals between the first and second anchor devices and a user device to determine locations of a user;
in a second instance, transmit, by the first anchor device, a communication signal received at the second anchor device, wherein the user is not using the user device;
a computing device including:
one or more processors; and
a memory including computer executable instructions that, when executed by the one or more processors, cause the computing device to:
store the locations and corresponding channel impulse responses of the communication signals;
obtain a channel impulse response of the communication signal received at the second anchor device; and
determine a location of the user within the positioning system by comparing the channel impulse response of the communication signal to the stored channel impulse responses and corresponding stored locations.

11. The positioning system of claim 10, wherein to automatically calibrate the positioning system, the first and second anchor devices are configured to:
transmit each communication signal which is received at the user device and at another anchor device;
receive a response communication signal from the user device;
determine one of the locations based on a round trip time of the transmitted communication signal and the response communication signal;
receive a transmitted communication signal from the other anchor device; and
transmit an indication of the determined location and a channel impulse response of the received communication signal to the computing device to store the determined location with the channel impulse response of the received communication signal.

12. The positioning system of claim 10, wherein to determine the location of the user, the instructions cause the computing device to:
assign a weight to each stored channel impulse response such that a sum of weighted, stored channel impulse responses produces the channel impulse response of the received communication signal;
apply the weight assigned to each stored channel impulse response to the corresponding location stored for the channel impulse response; and
combine the weighted, stored locations to determine the location of the user.

13. The positioning system of claim 10, wherein the instructions further cause the computing device to:
identify a user signature for the user during calibration based on characteristics of channel impulse responses for the communication signals transmitted when the user is using a user device;
store the user signature for the user; and
determine that the channel impulse response corresponds to the user of a plurality of users by comparing the characteristics of the channel impulse response to the stored user signature.

14. The positioning system of claim 10, wherein the received communication signal is a coded impulse signal.

15. The positioning system of claim 10 wherein the second anchor device is further configured to:
obtain a template coded impulse signal; and
compare the template coded impulse signal to the received coded impulse signal to reconstruct the channel impulse response.

16. The positioning system of claim 10, wherein the received communication signal is a first communication signal, the channel impulse response is a first channel impulse response, and the instructions further cause the computing device to:
obtain a second channel impulse response for a second communication signal received at the first anchor device and transmitted by the second anchor device; and
compare the first and second channel impulses responses to the stored channel impulse responses and corresponding stored locations.

17. The positioning system of claim 16, further comprising:
n anchor devices at n fixed locations within the positioning system configured to receive n×(n−1) communication signals from the n anchor devices, wherein the instructions cause the computing device to:
obtain n×(n−1) channel impulse responses of the n×(n−1) communication signals; and
compare the n×(n−1) channel impulses responses to the stored channel impulse responses and corresponding stored locations.

18. The positioning system of claim 10, wherein the first anchor device is a host anchor device which houses the computing device.

19. The positioning system of claim 10, wherein the computing device is a server device.

20. A computing device for determining a location of a user, the computing device comprising:
one or more processors; and
a memory including computer executable instructions that, when executed by the one or more processors, cause the computing device to:
automatically calibrate a positioning system by obtaining indications of locations of a user and corresponding channel impulses responses of communication signals received at anchor devices;
store the locations and corresponding channel impulse responses of the communication signals;
receive a channel impulse response for a communication signal transmitted by a first anchor device to a second anchor device when the user is not using a user device; and
determine a location of the user within the positioning system by comparing the channel impulse response of the communication signal to the stored channel impulse responses and corresponding stored locations.
